(19) United States
(12) Patent Application Publication
(10) Pub. No.: US 2009/0074074 A1
(43) Pub. Date: Mar. 19, 2009

(54) MULTIPLE DESCRIPTION ENCODER AND DECODER FOR TRANSMITTING MULTIPLE DESCRIPTIONS

(75) Inventors: Osar Chi Lim Au, Hong Kong (CN); Zhiqin Liang, Hong Kong (CN)

Correspondence Address: Thomas E. Watson;Amin, Turocy & Calvin, LLP, National City Center - 24th Floor, 1900 E. 9th Street, Cleveland, OH, 44114, US

(73) Assignee: THE HONG KONG UNIVERSITY OF SCIENCE AND TECHNOLOGY, Hong Kong (CN)

(21) Appl. No.: 12/191,933

(22) Filed: Aug. 14, 2008

Related U.S. Application Data
(63) Continuation-in-part of application No. 12/147,545, filed on Jun. 27, 2008.
(60) Provisional application No. 60/947,149, filed on Jun. 29, 2007.
(60) Provisional application No. 60/935,517, filed on Aug. 16, 2007.

(51) Int. Cl. H04B 1/66

(52) U.S. Cl. 375/240.18; 375/240.25

(57) ABSTRACT

An apparatus and method for joint reconstruction of multiple data streams is provided. An MD encoder can include a plurality of sub-encoders for encoding an input signal into a plurality of unique descriptions based on linear transformations and quantization of the input signal. An MD decoder can decode a plurality of unique descriptions associated with at least one input signal by utilizing a plurality of sub-decoders. Each sub-decoder can decode the plurality of unique descriptions based on coding noise variance and a coding error correlation coefficient associated with the plurality of unique descriptions. The MD decoder can include a joint reconstruction component that reconstructs the at least one input signal based on, at least in part, extracting a unique coding characteristic associated with each description of the plurality of unique descriptions and estimating a weighting factor for each description of the plurality of unique descriptions.

### CROSS-REFERENCE

This application is a continuation-in-part of pending U.S. patent application Ser. No. 12/147,545 filed Jun. 27, 2008 and entitled “VIDEO TRANSCODING QUALITY ENHANCEMENT,” which claims the benefit of U.S. Provisional Patent application Ser. No. 60/947,149, filed Jun. 29, 2007. This application also claims the benefit of U.S. Provisional Patent application Ser. No. 60/935,517 filed Aug. 16, 2007 and entitled “MULTIPLE DESCRIPTION VIDEO CODING FRAMEWORK BY JOINT RECONSTRUCTION OF MULTIPLE VIDEO STREAMS.” The entireties of the above-noted applications are incorporated by reference herein.

### TECHNICAL FIELD

The invention relates to the field of video coding, and more particularly, to utilizing noise statistics for multiple description video coding.

### BACKGROUND

With the recent growth of the Internet and success of wireless network technology, the transmission of video signals has experienced a significant increase in popularity. However, most video signal communication systems are limited in storage and/or bandwidth capacity. Because raw video signals are often very large in size, such storage and/or bandwidth limits can render the transmission of raw video signals over communication systems impracticable.

To allow transmission of video signals over such communication systems, video signals can be distributed and stored in compressed format. For example, in video streaming applications, a server can generate multiple coded streams, called descriptions, from a raw video signal and associated the descriptions with different channels. Multiple descriptions may be generated, each with different bit rates corresponding to varying network conditions. The descriptions can then be transmitted to one or more users, after which the users can reconstruct the video signal from the received bit streams. However, because video compression is a lossy process, the video signals reconstructed by each user will be distorted from the original raw video signal. Traditionally, when multiple descriptions having different bit rates are available, distortion is mitigated while reconstructing the original video by decoding the video bit-stream with the highest bit rate. However, this traditional approach does not take into consideration all of the available data, such as data present in the bit streams associated with lower bit rates, which could also be utilized to improve decoding performance. Accordingly, there exists a need in the art for techniques for reconstructing a video signal from video bit streams with a higher degree of precision.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject disclosure provides devices and methods for improved video signal reconstruction and video stream decoding. In accordance with various aspects presented herein, a multiple description (MD) encoder can encode an input signal into a plurality of unique descriptions utilizing a plurality of sub-encoders. Each sub-encoder of the plurality of sub-encoders can perform a linear transform and quantization of the input signal to generate one of the descriptions of the plurality of unique descriptions. An encoder controlling component can adjust the configuration of each sub-encoder of the plurality of sub-encoders to reduce encoding errors and cross correlation between every two descriptions of the plurality of unique descriptions. In accordance with one aspect, the unique coding characteristic includes at least one of reconstructed noise of the encoded bit stream, group of pictures (GOP), group of blocks (GOB), quantization steps, cost-functions of motion estimation, code rates, compression rates, noise characteristics, or distortion correlation. In accordance with another aspect, each sub-encoder of the plurality of sub-encoders can include a linear transform block, a quantizer block, and a motion estimation block. In accordance with yet another aspect, each sub-encoder of the plurality of sub-encoders compresses a bit stream of an associated description utilizing a unique computational complexity. In accordance with one aspect, the input signal is encoded based on at least one of the following video standards: H.261, H.263, H.264, VC-1, AVS, MPEG-1, MPEG-2, MPEG-4, or other video standard or the like.

In accordance with another aspect, a multiple description (MD) decoder can decode a plurality of unique descriptions associated with at least one input signal by utilizing a plurality of sub-decoders, wherein each sub-decoder of the plurality of sub-decoders is coupled to at least one of the plurality of unique descriptions. Each sub-decoder decodes the at least one of the plurality of unique descriptions based on coding noise variance of the at least one of the plurality of unique descriptions and a coding error correlation coefficient associated with the at least one of the plurality of unique descriptions. A joint reconstruction component can reconstruct the at least one input signal based on, at least in part, extracting a unique coding characteristic associated with each description of the plurality of unique descriptions and estimating a weighting factor for each description of the plurality of unique descriptions.

In accordance with yet another aspect, the unique coding characteristic can include at least one of reconstructed noise of a decoded unique description, group of pictures (GOP), group of blocks (GOB), quantization steps, cost-functions of motion estimation, code rates, compression rates, noise characteristics, or distortion correlation. In accordance with one aspect, one or more sub-decoders of the plurality of sub-decoders can partially decode an associated unique description, and the joint reconstruction component can reconstruct the at least one input signal as a function of a combination of the partially decoded unique descriptions. In accordance with another aspect, at least two sub-decoders of the plurality of sub-decoders can be associated with different input signals and can jointly decode descriptions related to an associated input signal. The joint reconstruction component can reconstruct the different input signals based on the jointly decoded descriptions. By jointly decoding multiple descriptions, an original video signal reconstructed from the descriptions can have significantly enhanced quality over a similar video signal reconstructed using traditional approaches. These MD coding/decoding techniques can be used to implement optimal or near-optimal N×M transforms for coding any number N of signal components for transmission over any number of channels.

In accordance with one aspect, a decoder can reconstruct linear transform coefficients, such as discrete cosine transform (DCT) coefficients, of a block of an original video signal by using a weighted superposition of corresponding coefficients in co-located blocks reconstructed from multiple descriptions. The weights applied to the linear transform coefficients from the descriptions can be adaptively determined so as to minimize the mean square error (MSE) of the coefficients. To facilitate this process, a quantization error model can also be used to track the MSE of the coefficients in the descriptions.

As disclosed herein, MD coding/decoding has two important features. First, MD coding/decoding enhances real-time interactive applications such as video phone and conferencing, for which retransmission of information is often not acceptable because of excessive delay. Second, MD coding/decoding simplifies network design because no feedback or retransmission of information is necessary and all data packets can be treated equally. This is in contrast to conventional techniques that utilize layered coding (LC), which generates a base layer and one or more enhancement layers that are dependent on the base layer. If the base layer is lost, the one or more enhancement layers would become useless and no video can be recovered. One major difficulty for the adoption of LC in practical network is that, to guarantee a basic level of quality, the base layer must be delivered almost error free. This requires different treatment of the base-layer and the one or more enhancement-layers, which makes network design very complicated. Therefore, MD coding/encoding is more attractive than conventional coding approaches for use in peer-to-peer multimedia delivery networks.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a multiple description encoder for encoding an input signal, in accordance with an embodiment of the invention.

FIG. 2 illustrates another multiple description encoder for encoding an input signal, in accordance with an embodiment of the invention.

FIG. 3 illustrates a multiple description decoder for decoding a plurality of unique descriptions associated with at least one input by utilizing a plurality of sub-decoders, in accordance with an embodiment of the invention.

FIGS. 4A and 4B are high-level block diagrams of devices that communicate and process bit streams, in accordance with an embodiment of the invention.

FIG. 4C illustrates coding characteristics of a GOP structure, in accordance with an embodiment of the invention.

FIG. 4D illustrates a multiple description decoder jointly reconstructing descriptions associated with different video streams, in accordance with an embodiment of the invention.

FIG. 5 is a block diagram of a system for compressing and reconstructing a bit streams, in accordance with an embodiment of the invention.

FIG. 6 is a block diagram of a system for reconstructing a video signal from multiple video streams, in accordance with an embodiment of the invention.

FIG. 7 illustrates error correlation data for an example video decoding system, in accordance with an embodiment of the invention.

FIG. 8 is a block diagram of an example system for receiving and processing video streams, in accordance with an embodiment of the invention

FIG. 9 is illustrates a methodology of processing bit streams, in accordance with an embodiment of the invention.

FIG. 10 is a block diagram of an example operating environment in which various aspects described herein can function.

FIG. 11 is a block diagram of an example networked computing environment in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

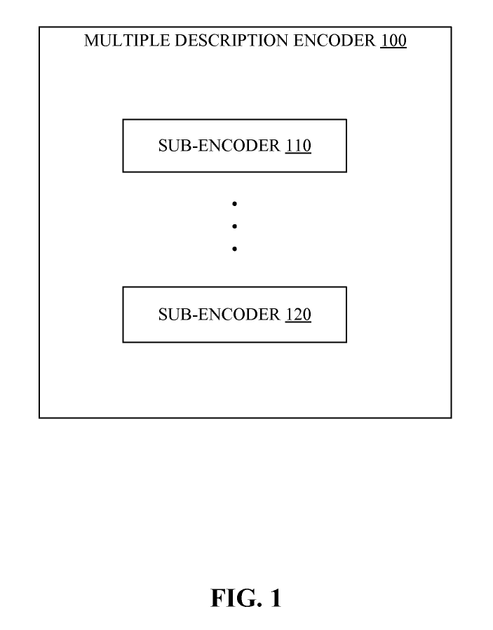

Referring to the drawings, FIG. 1 illustrates a multiple description (MD) encoder 100 for encoding an input signal into a plurality of unique descriptions utilizing a plurality of sub-encoders 110 to 120, in accordance with an embodiment of the invention. Each sub-encoder of the plurality of sub-encoders 110-120 performs a linear transform and quantization of the input signal to generate one of the descriptions of the plurality of unique description. By generating multiple unique descriptions from an input data stream for transmission, and reconstructing the input signal from characteristics and coding noise of the descriptions (see below), transmission quality of a data stream is improved because data error(s)/loss(es) can be independent between transmission of descriptions.

In one embodiment, the input signal can be a time domain video signal that is composed of one or more two-dimensional frames, each of which can in turn be composed of a series of blocks. In another embodiment, the different coding characteristics can include reconstructed noise of the encoded description, group of pictures (GOP), group of blocks (GOB), quantization steps, cost-functions of motion estimation, code rates, compression rates, one or more noise characteristics, and/or distortion correlation. In yet another embodiment, the unique descriptions generated by multiple description encoder 100 can be transferred to other devices through multiple connections. By way of a non-limiting example, the connections can be wired (e.g., Ethernet, IEEE-802.3, etc.) or wireless (IEEE-802.11, Bluetooth™, etc.) networking technology. Additionally, the connections can be directly connected to one another or indirectly connected through a third party device (not shown). As another example, the connections can be made via a cellular communications network such as the Global System for Mobile Communications (GSM), a Code Division Multiple Access (CDMA) communication system, and/or another suitable cellular communications network. Further, the descriptions can be stored in one or more storage devices, such as a hard disk, flash drive, xD card, SD card, MMC card, memory sticks, CD-ROM, CD-R, VCD, DVD-R, DVD+R, DVD+-RW, DVD-ROM, and any other storage devices, etc. In yet another embodiment, some of the descriptions can be obtained from storage devices, while others can be obtained by wired or wireless networking technologies.

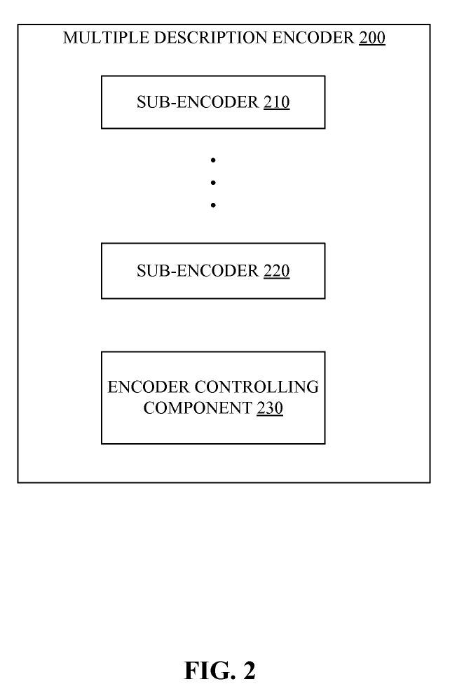

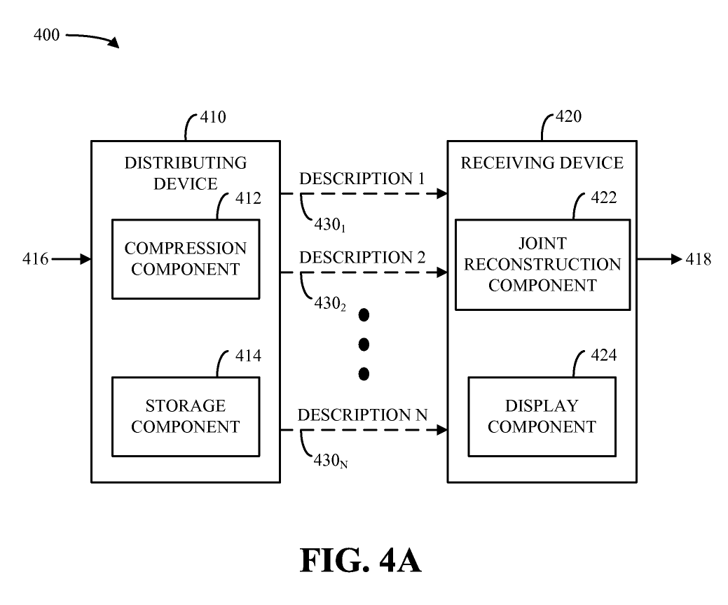

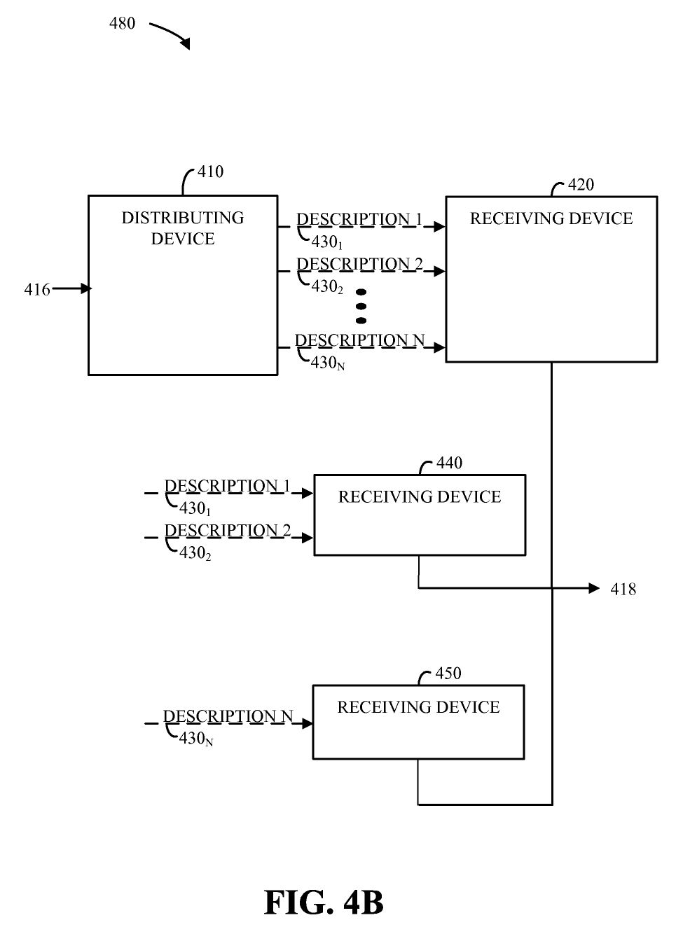

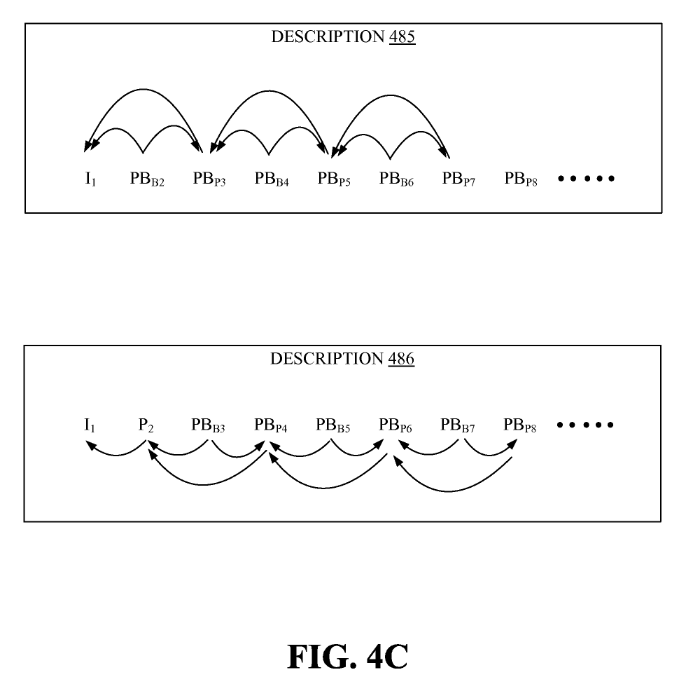

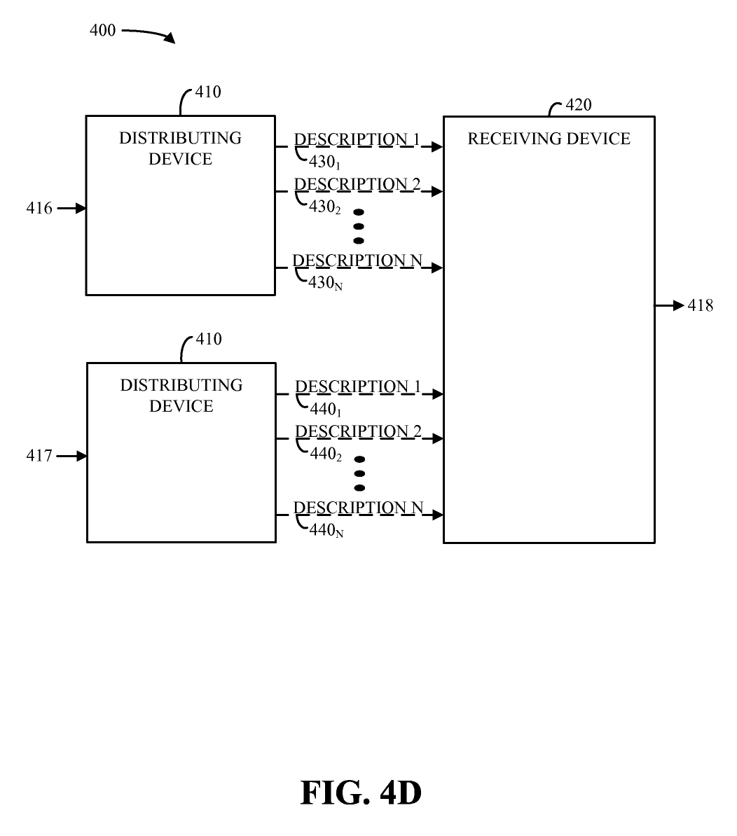

In one embodiment illustrated by FIG. 2, the MD encoder can include an encoder controlling component 230 that can adjust the configuration of each sub-encoder of the plurality of sub-encoders to reduce encoding errors and cross correlation between every two descriptions of the plurality of unique descriptions. Further, by way of a non-limiting example, the sub-encoders 210-220 can be H.263 video encoders, generating descriptions that are H.263 bit streams. In another example, sub-encoders 210-220 can be H.264 video encoders. In one aspect, the coding error of one description can be obtained by subtracting the reconstructed version of the one description from an input video stream. In another aspect, encoder controlling component 230 can generate an encoder configuration with a GOP structure illustrated by FIG. 4.

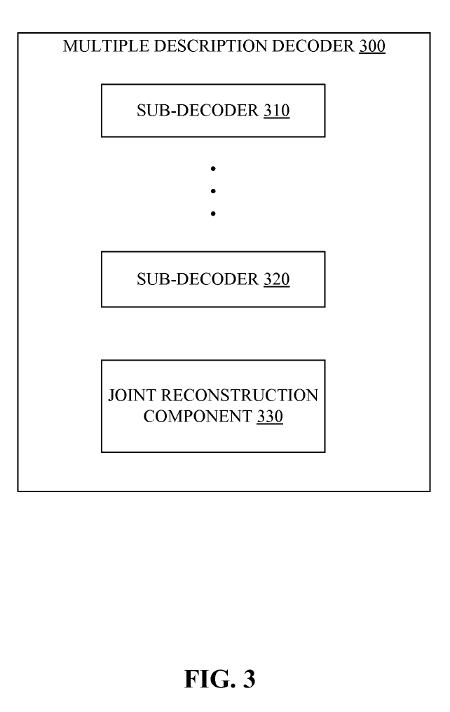

FIG. 3 illustrates a multiple description (MD) decoder 300 for decoding a plurality of unique descriptions associated with at least one input by utilizing a plurality of sub-decoders 310-320, in accordance with an embodiment of the invention. Each sub-decoder 310-320 can be coupled to at least one of the plurality of unique descriptions, wherein the at least one of the plurality of unique descriptions comprises a unique coding characteristic. Each sub-decoder 310-320 can decode the at least one of the plurality of unique descriptions based on coding noise variance of the at least one of the plurality of unique descriptions and a coding error correlation coefficient associated with the at least one of the plurality of unique descriptions. MD decoder 300 can also include a joint reconstruction component 330 that can reconstruct the at least one input signal based on, at least in part, extracting the unique coding characteristic associated with each description of the plurality of unique descriptions and estimating a weighting factor for each description of the plurality of unique descriptions.

FIGS. 4A and 4B illustrate high-level block diagrams of systems 400 and 480, respectively, for compressing and processing a raw signal 416, in accordance with various aspects presented herein. Raw signal 416 may be a wide variety of different types of signals, including data signals, speech signals, audio signals, image signals, 3D-video, multi-view video, graphics, and animation—in either compressed or uncompressed formats. In one example illustrated by FIG. 4A, system 400 can include a distributing device 410 that can encode raw signal 416 into descriptions with substantially identical content but different bit rates—each of the descriptions can be coupled to a receiving device 420. While only one distributing device 410 and one receiving device 420 are illustrated in system 400 for simplicity, it should be appreciated that system 400 can include any number of distributing devices 410 and/or receiving devices 420, each of which can communicate descriptions 430₁-430_{N} to one or more devices 410 and/or 420 in system 400.

In another example, a compression component 412 can generate the descriptions 430₁-430_{N} by compressing a raw signal 416 into multiple bit rates. While compression component 412 is illustrated in FIG. 4A as part of distributing device 410, it should be appreciated that compression component 412 can alternatively be external to the distributing device 410 and communicate generated descriptions 430₁-430_{N} to a storage component 414 and/or another appropriate component of the distributing device 410. In accordance with one aspect, compression component 412 can generate descriptions 430₁-430_{N} of different coding characteristics from a common raw signal 416.

In some embodiments of the invention, the coding characteristics are selected from the combination of reconstructed noise of the decoded description, group of pictures (GOP), group of blocks (GOB), quantization steps, cost-functions of motion estimation, code rates, compression rates, compression rates, bit rates, noise characteristic(s), and distortion correlation, etc. For example, a first receiving device 420 having a high bandwidth connection to the distributing device 410 can be configured to receive one or more video streams 430 with high bit rates from the distributing device 410, while a second receiving device 420 having a low bandwidth connection can instead be configured to receive video stream(s) 430 with lower bit rates. In an embodiment illustrated by FIG. 4B, multiple receiving devices (e.g., 420, 440, and 450) can receive any number of descriptions generated by distributing device 410, depending on desired coding characteristics. In other embodiments of the invention, the coding characteristics are the GOP structure.

FIG. 4C illustrates coding characteristics of a GOP structure, in accordance with an embodiment of the invention. It should be appreciated that other descriptions associated with different GOP structures could be generated by distributing device 410. Descriptions 485 and 486 consist of 8 frames: an I-frame (i.e., anchor frame that corresponds to a fixed image and is independent of other picture types) and B-frames (i.e., bidirectional predictive frames that contain difference information between adjacent frames) alternating with P-frames (i.e., predictive frames that contain motion compensated difference information from a preceding P-frame). As illustrated, description 485 is encoded in a different GOP structure from the GOP structure of description 486 (e.g., frame 2 of description 485 is coded to a B frame, and frame 2 of description 486 is coded to a P frame). Since a P frame is predicted from an algorithm different from the B frame, it is associated with different coding errors; therefore, jointly reconstructing descriptions 485 and 486 in accordance with embodiments disclosed herein results in improved signal reconstruction and decoding. In this way, an MD decoder 300 can reconstruct a description with higher accuracy because more noise statistics can be collected when description coding characteristics are independent and/or less related to each other.

Alternatively, the descriptions 430₁-430_{N} can be generated by the compression component 412 in connection with varying levels or tiers of service provided by the distributing device 410 having corresponding monetary rates associated therewith. Once generated, the descriptions 430₁-430_{N} can be transmitted to a receiving device 420 and/or stored by the storage component 414 at the distributing device 410 for later transmission to a receiving device 420. In general, receiving device 420 receives M descriptions and jointly reconstructs the M descriptions into a reconstructed discrete-time signal. Note that M is an integer greater than or smaller than N.

By way of non-limiting example, a distributing device 410 and a receiving device 420 can be communicatively connected via a wired (e.g., Ethernet, IEEE-802.3, etc.) or wireless (IEEE-802.11, Bluetooth™, etc.) networking technology. Additionally, a distributing device 410 and a receiving device 420 can be directly connected to one another or indirectly connected through a third party device (not shown). For example, a distributing device 410 can be a web server and a receiving device 420 can be a client computer that accesses the distributing device 410 from the Internet via an Internet service provider (ISP). As another example, a receiving device 420 can be a mobile terminal that accesses video streams 430 from the distributing device 410 via a cellular communication network such as the Global System for Mobile Communications (GSM), a Code Division Multiple Access (CDMA) communication system, and/or another suitable cellular communication network.

In accordance with one aspect, a raw video signal used by compression component 412 to generate the descriptions 430₁-430_{N} can be discarded after the descriptions 430₁-430_{N} are generated, due to storage limits at distributing device 410. Thus, only the compressed descriptions 430₁-430_{N} generated from the original raw signal may be available to receiving device 420. In one example, receiving device 420 can obtain a video signal corresponding to one or more descriptions 430₁-430_{N} by reconstructing the descriptions 430₁-430_{N}. However, because video compression (e.g., video compression employed by compression component 412) is a lossy process, distortion (coding noise) can be present in a reconstructed video signal obtained by receiving device 420.

To mitigate coding noise, a receiving device 420 can include a joint reconstruction component 422 that can jointly decode multiple descriptions 430₁-430_{N} generated from a common raw signal 416 having different coding characteristics. In one example, compression component 412 compresses raw signal 416 into descriptions 430₁-430_{N} by utilizing a subset of information present in raw signal 416 and discarding the remainder. As the bit rate of a description 430ᵢ increases, the amount of information from raw signal 416 retained in description 430ᵢ can likewise increase. Due to varying quantization steps and other mechanisms that can be utilized by compression component 412 to compress raw signal 416 into descriptions 430₁-430_{N}, descriptions 430₁-430_{N} having different bit rates may include non-overlapping information from original raw (e.g., video) signal 416. In accordance with one aspect, joint reconstruction component 422 can utilize this non-overlapping information from multiple video streams 430 to jointly reconstruct a reconstructed signal using multiple video streams 430.

FIG. 4D illustrates a reconstruction component 422 that includes a multiple description decoder for jointly reconstructing descriptions associated with different video streams 416 and 417, in accordance with an embodiment of the invention. For example, in a multi-video coding environment utilizing multiple video signals from adjacent cameras (e.g., input signals 416 and 417), descriptions of one video camera can be combined with descriptions of another video camera. In one embodiment, at least two sub-decoders can be associated with input signals 416 and 417 and jointly decode descriptions related to input signals 416 and 417. Joint reconstruction component 422 can reconstruct input signals 416 and 417 based on the jointly decoded descriptions to generate reconstructed signal 418. By doing so, reconstructed signal 418 can have a higher quality than a signal obtained by reconstructing any individual description 430i. In one example, a reconstructed signal 418 can then optionally be provided to display component 424 at receiving device 420 for display. Display component 424 and/or another suitable component associated with receiving device 420 can additionally perform appropriate pre-processing operations on the reconstructed video signal prior to display, such as rendering, buffering, and/or other suitable operations.

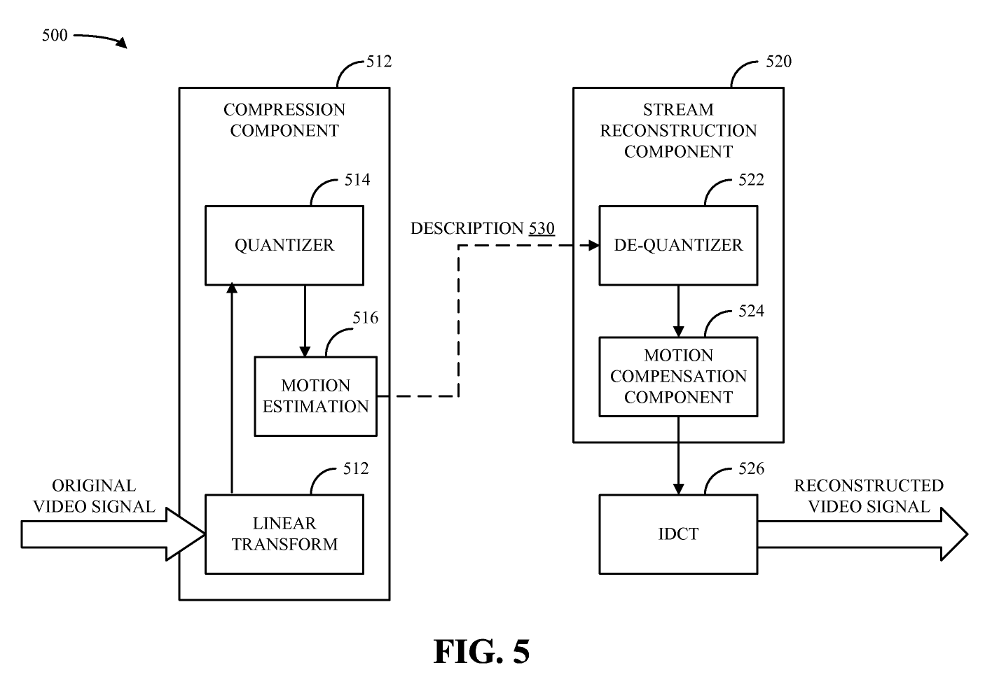

Referring now to FIG. 5, a block diagram of a system 500 for compressing and reconstructing a raw video signal is illustrated. In accordance with one aspect, an original raw video signal can be received by a compression component 512. In one example, the original video signal can be a time domain signal that is composed of one or more two-dimensional frames, each of which can in turn be composed of a series of blocks. By way of specific, non-limiting example, blocks in the video signal can represent 8×8 pixel areas (or macro-blocks) in the video signal, and/or other suitable sizes and/or arrangements of pixels. As another specific, non-limiting example, the blocks in the video signal can include intra-coded blocks (“I-blocks”), which are generated based only on information located at the frame in which the block is located; inter-coded blocks (“prediction blocks” or “P-blocks”), which can be generated based on information in the current frame as well as immediately preceding and/or succeeding frames; and/or other types of blocks.

In accordance with one aspect, compression component 512 can compress the original video signal by determining and truncating information in respective blocks present in the video signal that correspond to areas of low-frequency deviation between pixels. For example, the compression component can determine and truncate information corresponding to low-frequency deviation in color, intensity, and/or other appropriate measurements between pixels. To facilitate this process, compression component 512 can convert the original video signal to the frequency domain by performing a linear transform 512 on the original video signal. In preferred embodiments of the invention, the linear transform is a Discrete Cosine Transform (DCT).

In one example, after a DCT is performed at 512, each block in the transformed signal can have DCT coefficients corresponding to deviation frequencies between pixels in the block. These coefficients can include one DC coefficient, which represents an average value for the pixels in the block, and a set of AC coefficients that represent change through the pixels in the block at respective increasing frequencies. As used generally herein, a k-th frame in a video signal is denoted as Fₖ. Further, xᵢ(Fₖ) is used to represent the i-th DCT coefficient in an original video signal, and xᵢ(Fₖ, Vₗ) is used to represent the i-th DCT coefficient in a reconstructed video signal corresponding to an l-th description Vₗ.

In accordance with another aspect, quantization and motion estimation can be applied on the respective blocks of a DCT-transformed video signal using a quantizer 514 and motion estimation 516 at the compression component 512, generating a description 530. The description 530ᵢ can be transmitted to a stream reconstruction component 520, which can de-quantize the blocks using a de-quantizer 522 in order to reconstruct the video signal from the description 530ᵢ. As used herein, the expressions Q(V, Qₚ) and DeQ(L, Qₚ) respectively refer to a quantization mapping used by quantizer 514 and a de-quantization mapping used by the de-quantizer 522. As used in the expressions, V represents input to quantizer 514, L represents input to de-quantizer 522, and Qₚ represents a quantization step.

In one example, intra-coded blocks and inter-coded blocks can be quantized differently by quantizer 514. Accordingly, quantization mappings used by quantizer 514 for intra-coded blocks and inter-coded blocks are respectively expressed herein as Q^{I}(V,Qₚ) and Q^{P}(V,Qₚ). By way of specific example, the following quantization mappings may be used by quantizer 514 to quantize the DCT coefficients of the converted original video signal:

$$\begin{matrix}Q ( V , {Q}_{p} ) = \{ \begin{matrix}{Q}^{I} ( V , {Q}_{p} ) & if intracoded \\ {Q}^{P} ( V , {Q}_{p} ) & otherwise ,\end{matrix} & ( 1 ) \\ {Q}^{I} ( V , {Q}_{p} ) = floor ( \frac{\vert V \vert}{2 {Q}_{p}} ) \cdot sign ( V ) , & ( 2 ) \\ {Q}^{P} ( V , {Q}_{p} ) = floor ( \frac{\vert V \vert - {Q}_{p} / 2}{2 {Q}_{p}} ) \cdot sign ( V ) , & ( 3 )\end{matrix}$$

where floor(·) is used to round an input to the nearest integer that is smaller than the input, and sign(·) is used to return the sign of the input. By way of further specific, non-limiting example, a quantization step of Qₚ=8 may be used for the DC coefficient of intra-coded blocks.

In accordance with another aspect, quantized intra-coded and inter-coded blocks may be transmitted as a description 530ᵢ to stream reconstruction component 520. Upon receiving description 530ᵢ, de-quantizer 522 of stream reconstruction component 520 can then de-quantize the blocks in the video stream 530. In one example, de-quantizer 522 can utilize the same de-quantization mapping DeQ(L,Qₚ) to de-quantize the DCT coefficients of video stream 530 for both intra-coded and inter-coded blocks. This mapping can be expressed as follows:

$$DeQ ( L , {Q}_{p} ) = \{ \begin{matrix}{Q}_{p} \cdot ( 2 \cdot L + 1 ) & if {Q}_{p} is odd \\ {Q}_{p} \cdot ( 2 \cdot L + 1 ) - 1 & otherwise .\end{matrix} \qquad ( 4 )$$

Accordingly, based on Equations (1)-(4), a reconstructed signal corresponding to an input V generated by de-quantizer 522 at the stream reconstruction component 520 can be defined as follows:

Rec(V,Qₚ)=DeQ(Q(V,Qₚ),Qₚ). (5)

In one example, the de-quantized signal generated by de-quantizer 522 has an associated degree of uncertainty. More particularly, for a particular reconstructed value v, multiple values of V may exist that could result in a de-quantized value of v (e.g., multiple values of V could satisfy Rec(V, Qₚ)=\tilde{v}). Based on this uncertainty, a lower bound value LB(\tilde{v}, Qₚ) and an upper bound value UB(\tilde{v}, Qₚ) can be defined as the minimum and maximum values of V that satisfy Rec(V, Qₚ)=\tilde{v}. As a result, with a quantization step of Qₚ, if V is reconstructed to v by the de-quantizer 522, then the cell (or “range”) of the original signal V can be expressed as follows:

Vε[LB(\tilde{v},Qₚ),UB(\tilde{v},Qₚ)]. (6)

In one example, an intra-coded DCT coefficient xᵢ(Fₖ) (e.g., a coefficient corresponding to an I-block) can be reconstructed by de-quantizer 522 as follows:

\tilde{x}ᵢ(Fₖ,Vₗ)=Rec(xᵢ(Fₖ),Qₚ). (7)

Further, by way of specific, non-limiting example, the AC coefficients for a given I-block can conform to a zero-mean Laplacian probability distribution. To this end, the Laplacian probability density function (PDF) ƒ_{F}_{ₖ}_{,V}_{ₗ}ⁱ(x) for each coefficient in an I-block can be expressed as follows:

$${f}_{{F}_{k} , {V}_{l}}^{i} ( x ) = \frac{1}{2 {λ}_{{F}_{k} , {V}_{l}}^{i}} {e}^{- \vert x \vert / {λ}_{{F}_{k} , {V}_{l}}^{i}} , \qquad ( 8 )$$

where λ_{F}_{ₖ}_{,V}_{ₗ}ⁱ is a rate parameter of the distribution of the i-th coefficient of frame Fₖ in stream Vₗ. In one example, the rate parameter of the PDF ƒ_{F}_{ₖ}_{,V}_{ₗ}ⁱ(x) can be estimated by observing the distribution of \tilde{x}ᵢ(Fₖ, Vₗ).

Additionally and/or alternatively, an inter-coded DCT coefficient xᵢ(Fₖ) (e.g., a coefficient corresponding to a prediction block) can be reconstructed by de-quantizer 522 as follows. First, the expression pᵢ(Fₖ₋₁, Vₗ) can be used to denote the i-th DCT coefficient of the prediction block generated by the previous frame Fₖ₋₁. The expression rᵢ(Fₖ, Vₗ) can then be used to denote the i-th DCT coefficient of the residual signal, which can be obtained using the following equation:

xᵢ(Fₖ)=pᵢ(Fₖ₋₁,Vₗ)+rᵢ(Fₖ,Vₗ). (9)

Based on the expressions pₗ(Fₖ₋₁, Vₗ) and rₗ(Fₖ, Vₗ), and Equation (9), the reconstructed version of the i-th DCT coefficient of the residual of an l-th stream Vₗ can be expressed as follows:

\tilde{r}ᵢ(Fₖ,Vₗ)=Rec(rᵢ(Fₖ,Vₗ),Qₚ) (10)

Based on Equations (9) and (10), an inter-coded DCT coefficient rₗ(Fₖ, Vₗ) can then be reconstructed by de-quantizer 522 as follows:

\tilde{x}ᵢ(Fₖ,Vₗ)=pᵢ(Fₖ₋₁,Vₗ)+\tilde{r}ᵢ(Fₖ,Vₗ). (11)

By way of specific, non-limiting example, the distribution of rᵢ(Fₖ, Vₗ) can also be Laplacian. Accordingly, the PDF for the distribution of rᵢ(Fₖ, Vₗ) can be similar in form to Equation (8) with a different rate parameter. In one example, the rate parameter for the distribution of rᵢ(Fₖ, Vₗ) can be obtained by observing the distribution of \tilde{r}ᵢ(Fₖ, Vₗ) in a similar manner to Equation (8) for the distribution of AC coefficients in an I-block.

In accordance with another aspect, the stream reconstruction component 520 can further include motion compensation component 524. In one example, motion compensation component 524 can obtain a minimum mean square error (MMSE) reconstruction of the original video signal by utilizing the distribution of DCT coefficients, the quantization step applied by the quantizer 514, and the upper and lower bounds for each coefficient to estimate reconstructed coefficients within the range for each coefficient that minimizes the mean square error (MSE) of the reconstructed video signal.

In one specific example, motion compensation component 524 can perform MMSE reconstruction using the Lloyd-Max method. As used herein, the abbreviated expression x is used in place of xᵢ(Fₖ, Vₗ), which represents the i-th coefficient in a k-th frame Fₖ of an l-th description Vₗ 530ₗ. Accordingly, motion compensation component 524 can utilize the Lloyd-Max method to determine an optimal reconstruction for an intra-coded block based on the following equation:

$${x}_{opt} = \frac{{\int }_{l}^{u} xf ( x ) d x}{{\int }_{l}^{u} f ( x ) d x} , \qquad ( 12 )$$

where l=LB(\tilde{x}, Qₚ), u=UB(\tilde{x}, Qₚ) Qₚ is the size of the quantization step used by quantizer 514, and f(x) represents the distribution of the DCT coefficients of the block. Similarly, motion compensation component 524 can determine an MMSE reconstruction of the residual portion of an inter-coded block by using the following equation:

$${r}_{opt} = \frac{{\int }_{{l}^{′}}^{{u}^{′}} rf ( r ) d r}{{\int }_{{l}^{′}}^{{u}^{′}} f ( r ) d r} \qquad ( 13 )$$

where l′=LB(\tilde{r}, Qₚ), u′=UB(\tilde{r}, Qₚ) Qₚ is the size of the quantization step used by the quantizer 214, and f(r) represents the distribution of the DCT coefficients of the residual block. Based on Equations (12) and (13), an optimal reconstruction of a video signal 530 as determined by the motion compensation component 524 can then be expressed as follows:

xₒₚₜ=p+rₒₚₜ. (14)

In accordance with one aspect, upon reconstruction of a video description 530ᵢ by stream reconstruction component 520, an inverse linear transform 526 can be performed on the reconstructed signal to convert the reconstructed signal back to the time domain. After conversion to the time domain via inverse linear transform 526, the reconstructed video signal can be further processed and/or displayed by a receiving device (e.g., a receiving device 420). Inverse linear transform 526 may be a counterpart device of compression component 512. For example, if linear transform 512 is a DCT, then inverse linear transform 526 is an inverse DCT (IDCT).

In accordance with another aspect, the MSE of the reconstruction performed by stream reconstruction component 520 for intra-coded blocks and inter-coded blocks in a video stream 530 can be expressed as MSE_{I}(xₒₚₜ) for intra-coded blocks and MSE_{P}(xₒₚₜ) for inter-coded blocks. Further, MSE for the respective types of blocks can be determined based on the following equations:

$$\begin{matrix}{MSE}_{I} ( {x}_{opt} ) = {\int }_{l}^{u} {( x - {x}_{opt} )}^{2} f ( x ) d x , & ( 15 ) \\ \begin{matrix}{MSE}_{P} ( {x}_{opt} ) = {\int }_{{l}^{′}}^{{u}^{′}} {( ( p + r ) - ( p + {r}_{opt} ) )}^{2} f ( r ) d x \\ = {\int }_{{l}^{′}}^{{u}^{′}} {( r - {r}_{opt} )}^{2} f ( r ) d x .\end{matrix} & ( 16 )\end{matrix}$$

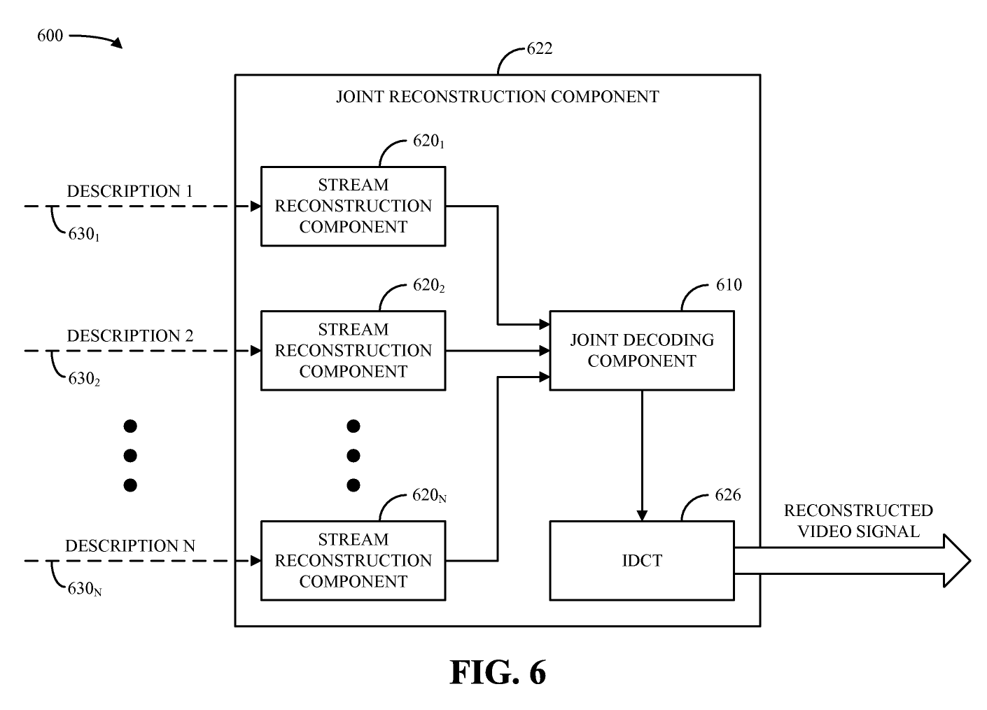

Turning to FIG. 6, a block diagram of a system 600 for reconstructing a video signal from multiple descriptions 630₁-630_{N} in accordance with various aspects is illustrated. In one example, system 600 includes a joint reconstruction component 622, which can be employed by a receiving device (e.g., a receiving device 420) and/or another suitable device. The joint reconstruction component 622 can obtain multiple descriptions 630 (e.g., from a distributing device 410), each of which can be compressed from the same raw video signal at different bit rates. Each description 630 can be initially processed by one or more stream reconstruction components 520 as generally described supra with regard to system 500. In one embodiment, one or more descriptions can be partially decoded, and joint reconstruction component 622 can reconstruct at least one input signal as a function of a combination of the partially decoded one or more descriptions.

While system 600 illustrates a stream reconstruction component 620 corresponding to respective descriptions 630, it should be appreciated that fewer stream reconstruction components 620 can be employed by joint reconstruction component 622, and respective stream reconstruction components 620 can individually and/or jointly process any number of descriptions 630. For example, joint reconstruction component 622 can contain a single stream reconstruction component 620 that initially processes all descriptions 630. In accordance with one aspect, the reconstructed individual streams can then be provided to a joint decoding component 610, which can combine information from the reconstructed streams to reconstruct the raw video signal represented by the descriptions 630. An IDCT 626 can then be performed on the jointly reconstructed video signal to convert the signal to the time domain for display and/or other processing.

In accordance with one aspect, joint decoding component 610 can reconstruct a video signal from multiple descriptions 630₁-630_{N} by utilizing a least square estimate (LSE) criterion. In one example, LSE joint decoding can be performed by joint decoding component 610 as follows. First, from n descriptions 630₁-630_{N} representing the same original raw signal, which can be represented as (V₁, . . . , Vₙ), optimal DCT coefficients for each individual description 630 in the MMSE sense can be determined by respective stream reconstruction component(s) 620 using Equations (12) and (14).

As used herein, DCT coefficients corresponding to each description 630 are collectively referred to as x and the indices i are omitted. Accordingly, the joint decoding component 610 can receive a column vector X_{MMSE}=(xₒₚₜ₁, . . . , xₒₚₜₙ)^{T}, which represents the MMSE reconstructions of the collocated DCT coefficients from descriptions (V₁, . . . , Vₙ) as performed by the respective stream reconstruction component(s) 620. Additionally, joint decoding component 360 can receive a column vector Err=(e₁, . . . , eₙ)^{T} of random variables that represent the reconstruction error from each description 630. Based on these input vectors, the joint decoding component 610 can determine a least square estimate of an original video signal x as follows:

x_{LSE}=X_{MMSE}^{T}·W, (17)

where W=(w₁, . . . , wₙ) represents a set of weights subject to the constraint

$${\sum }_{i = 1}^{n} {w}_{n} = 1$$

that minimizes the following:

E[(x−x_{LSE})²]=E[(Err^{T}·W)²] (18)

Joint decoding component 610 can then determine the value of each weight wᵢ by differentiating Equation (18) with respect to wᵢ for 1≦i≦n and solving the resulting n equations together with the constraint

$${\sum }_{i = 1}^{n} {w}_{n} = 1.$$

In one example, joint reconstruction component 622 can then generate a reconstructed video signal by combining each reconstructed description according to their corresponding determined weights and performing an IDCT 626 on the result.

In the specific, non-limiting example where two descriptions 360₁ and 630₂ are present in the system 600, the error variance of each stream after reconstruction by respective stream reconstruction component(s) 620 can be respectively expressed as σ₁²=E[e₁²] and σ₂²=E[e₂²]. Further, the error correlation coefficient between the two reconstructed streams can be expressed as ρ=E[e₁e₂]/σ₁σ₂. Based on these definitions, a set of weights W can be determined by the joint decoding component 610 as follows:

$$W = ( \frac{{σ}_{2}^{2} - {σ}_{1} {σ}_{2} ρ}{{σ}_{1}^{2} + {σ}_{2}^{2} - 2 {σ}_{1} {σ}_{2} ρ} , \frac{{σ}_{1}^{2} - {σ}_{1} {σ}_{2} ρ}{{σ}_{1}^{2} + {σ}_{2}^{2} - 2 {σ}_{1} {σ}_{2} ρ} ) , \qquad ( 19 )$$

where the error variances σ₁ and σ₂ of each DCT coefficient can be calculated with respect to Equations (15) and (16). In one example, the error correlation p can be obtained by simulation.

When two descriptions 630 are present and optimal weights W are utilized by joint decoding component 610, the expected mean square error of the LSE estimation performed by joint decoding component 610 can be expressed as follows:

$$E [ {( x - {x}_{LSE} )}^{2} ] = \frac{{σ}_{1}^{2} {σ}_{2}^{2} ( 1 - {ρ}^{2} )}{{σ}_{1}^{2} + {σ}_{2}^{2} - 2 {σ}_{1} {σ}_{2} ρ} . \qquad ( 20 )$$

Generally, the weights can be calculated from the following equation:

$$\begin{matrix}[ \begin{matrix}{w}_{1} \\ {w}_{2} \\ ⋮ \\ {w}_{n}\end{matrix} ] = {M}_{V} \cdot [ \begin{matrix}{σ}_{v 1}^{2} - {σ}_{v 1} {σ}_{vn} {ρ}_{1 n} \\ {σ}_{v 2}^{2} - {σ}_{v 2} {σ}_{vn} {ρ}_{2 n} \\ ⋮ \\ {σ}_{vn - 1}^{2} - {σ}_{vn - 1} {σ}_{vn} {ρ}_{( n - 1 ) n}\end{matrix} ] , \\ wherein & ( 21 ) \\ {M}_{v} = {[ \begin{matrix}{E [ ( {v}_{1} - {v}_{n} ) ]}^{2} ] & E ( [ {v}_{1} - {v}_{n} ) ( {v}_{1} - {v}_{n} ) ] & … & E [ ( {v}_{n - 1} - {v}_{n} ) ( {v}_{1} - {v}_{n} ) ] \\ E [ ( {v}_{1} - {v}_{n} ) ( {v}_{2} - {v}_{n} ) & {E [ ( {v}_{2} - {v}_{n} ) ]}^{2} ] & … & … \\ ⋮ & ⋮ & ⋮ & ⋮ \\ E [ ( {v}_{1} - {v}_{n} ) ( {v}_{n - 1} - {v}_{n} ) & … & … & {E [ ( {v}_{n - 1} - {v}_{n} ) ]}^{2} ]\end{matrix} ]}^{- 1} & ( 21 )\end{matrix}$$

By way of another specific, non-limiting example, joint reconstruction component 622 can be used to reconstruct a video signal from multiple descriptions 630 that are compressed using an H.263 codec. As the H.263 codec utilizes 8×8 blocks, a stream reconstruction component 620 of a joint reconstruction component 622 can reconstruct a given description 630 by collecting statistics for each of the 64 corresponding DCT coefficients in each presently inter-coded and intra-coded block in the description 630. By doing so, the rate parameters for coefficient distribution can be obtained by observing the distributions 630. For example, when an I-frame is decoded, rate parameters for the coefficients of corresponding intra-coded blocks can be estimated as described supra with regard to Equation (8). Additionally, when a P-frame is decoded, rate parameters for the coefficients of inter-coded blocks in the following P-frame can be estimated as described supra with regard to Equations (10) and (11). In another specific example, descriptions 630 are compressed by an H.261, H.264, VC-1, AVS, MPEG-1, MPEG-2, or MPEG-4 codec—or other video codec or the like.

Next, given the DCT distribution, MMSE decoding can be performed for each present description 630ᵢ in the DCT domain by respective stream reconstruction component(s) 620 as described supra with regard to Equations (12)-(14). In one example, this process can be embedded into the decoding process after de-quantization of the image and/or residue for I-blocks and/or P-blocks but before an IDCT 526 is performed. This process can include calculating an MMSE estimate for each coefficient and its corresponding MSE and then computing a LSE joint estimate of the respective coefficients via the joint decoding component 610. An IDCT 626 can then be performed on the LSE-estimated coefficients to obtain an enhanced video reconstruction.

In an additional example, operation of joint reconstruction component 622 can be further simplified by performing LSE decoding only on the first few DCT coefficients of respective reconstructed blocks due to the fact that the power of respective high frequency DCT coefficients is relatively small as compared to the power of lower frequency DCT coefficients. By way of specific, non-limiting example, coefficients for each DCT block can be LSE decoded by joint decoding component 610 in zigzag order. When the power of a coefficient is less than the expected MSE of the MMSE estimation, LSE decoding for the block can be terminated. By performing decoding in this manner, sufficient performance can be obtained by performing LSE decoding on approximately 20% of the coefficients present in the descriptions 630.

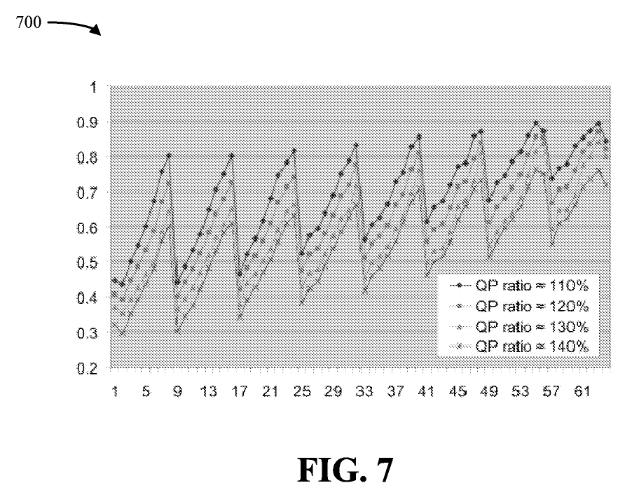

Referring next to FIG. 7, a graph 700 is provided that illustrates error correlation data for an example video decoding system in accordance with various aspects described herein. More particularly, graph 700 illustrates example error correlation coefficients ρ between two reconstructed video streams (V₁, V₂) with different quantization steps (Qₚ₁, Qₚ₂). If reconstructions V₁ and V₂ are inter-coded, it can be observed from Equation (10) that ρ can be a function of the ratio of Qₚ₁/Qₚ₂ and the residual covariance of the two video streams, which can be expressed as (E[rᵢ(Fₖ, V₁)·rᵢ(Fₖ, V₂)]).

In one example, representative error correlation coefficients ρ can be obtained by fixing the ratio Qₚ₁/Qₚ₂ and measuring ρ in various simulation sequences. The simulation results can then be averaged to obtain coefficients ρ as a function of quantization step ratio. Graph 700 illustrates resulting values of ρ for each of the 64 DCT coefficients present in blocks of various simulation sequences in scanning order for 4 different quantization step ratios. It should be appreciated that while ρ is approximated in graph 700, the approximations used are nonetheless accurate due to the slow variation of ρ. It can additionally be seen from graph 700 that the error correlations obtained for lower-frequency coefficients are smaller than those obtained for higher-frequency coefficients.

In another specific example, if two reconstructed video streams are both intra-coded, it can be observed from Equation (7) that the corresponding ρ can be a function of Qₚ₁/Qₚ₂ and the distribution of xᵢ(Fₖ)). As a result, the error correlation coefficients ρ for such a case can be estimated in a similar manner to that illustrated by graph 470. In yet another specific example, reconstructed signals coded with different modes, e.g., an intra-coded V₁ and an inter-coded V₂, can have an error correlation coefficient of ρ=0 as the signal is independent before quantization.

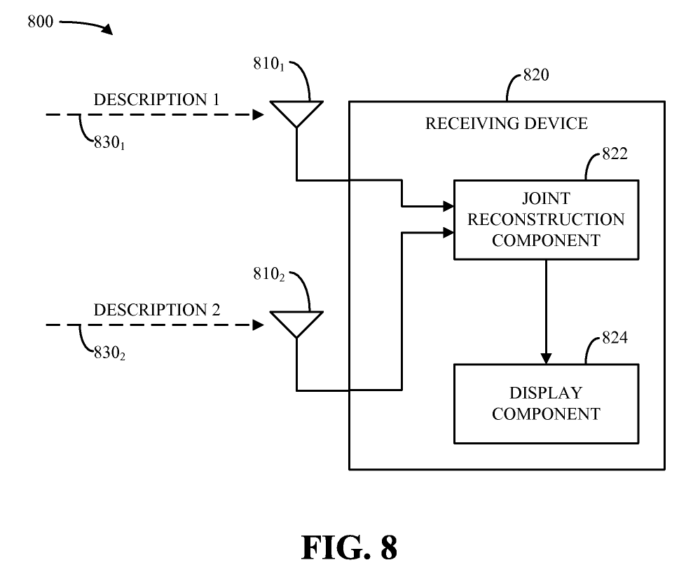

Referring to FIG. 8, a block diagram of an example system 800 for receiving and processing descriptions 830 is illustrated. In accordance with one aspect, system 800 can include a receiving device 820, to which multiple descriptions 30 can be transmitted (e.g., by a distributing device 410). In one example, descriptions 830 are generated (e.g., by a compression component 512) from a common video signal using different bit rates. Receiving device 820 can include a joint reconstruction component 822 and/or a display component 824, each of which can operate in accordance with various aspects described herein.

In one example, receiving device 820 can include one or more antennas 810, each of which can receive one or more descriptions 830. In accordance with one aspect, respective descriptions 830 received by antenna(s) 810 at receiving device 820 can be provided to a joint reconstruction component 822 at receiving device 820. While only two descriptions 830 and two antennas 810 are illustrated for brevity, it should be appreciated that system 800 can include any number of descriptions 830 and/or antennas 810. By way of a specific, non-limiting example, receiving device 820 can be a mobile telephone or similar device that employs one or more antennas 810 for receiving descriptions 830 from a wireless access point and/or another appropriate transmitting entity.

Additionally and/or alternatively, the number of descriptions 830 transmitted to receiving device 820 may be greater than the number of antennas 810 present at receiving device 820. Accordingly, antenna(s) 810 at receiving device 820 can respectively be configured to receive descriptions 830. For example, an antenna 810 at receiving device 820 can receive multiple descriptions 830 sequentially in time, or alternatively an antenna 810 can receive a plurality of multiplexed descriptions 830 simultaneously (e.g., based on code division multiplexing (CDM), frequency division multiplexing (FDM), and/or another appropriate multiplexing technique).

In one example, to facilitate sequential and/or multiplexed reception and processing of descriptions 830, joint reconstruction component 822 can employ various buffering and/or storage mechanisms. In another example, system 800 can include multiple receiving devices 820 having one or more antennas 810, and each receiving device 820 can be configured to receive only a subset of available descriptions 830. For example, a first receiving device 820 can be configured to receive only a first description 830 having a first bit rate, and a second receiving device 820 can be configured to receive only a second description 830 having a second bit rate. Such a scenario can occur, for example, due to variations in the communication capabilities of the receiving devices 820, variations in network conditions between the receiving devices 820 and a transmitting entity, and/or other factors. In such an example, antennas 810 located at each receiving device 820 can be operable both to receive descriptions 830 and to communicate received descriptions 830 to other receiving devices 820 to facilitate joint reconstruction of the descriptions in accordance with various aspects described herein.

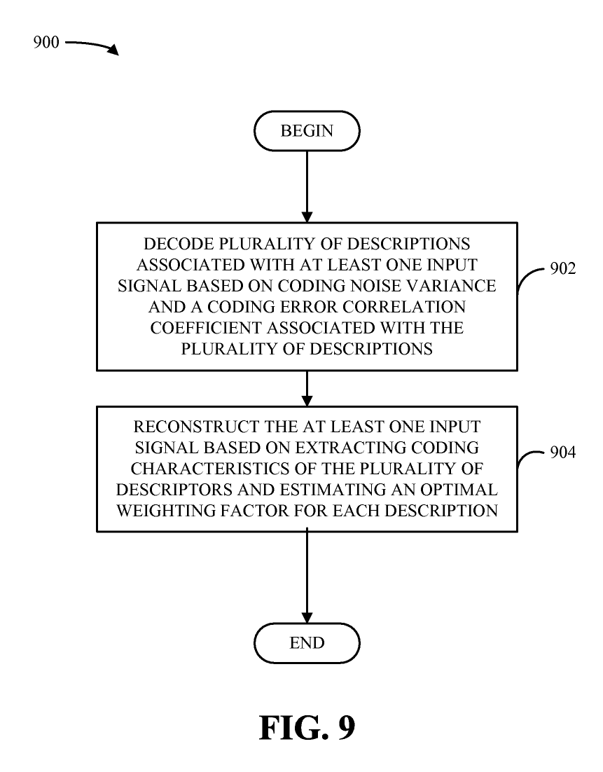

FIG. 9 illustrates a methodology in accordance with the disclosed subject matter. For simplicity of explanation, the methodology is depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 9, an example methodology 900 of processing bit streams is illustrated, in accordance with an embodiment of the invention. At 902, a plurality of unique descriptions associated with at least one input signal can be decoded based on coding noise variance of the plurality of unique descriptions and a coding error correlation coefficient associated with the plurality of unique descriptions. At 904, a joint reconstruction component can reconstruct the at least one input signal based on, at least in part, extracting the unique coding characteristic associated with each description of the plurality of unique descriptions and estimating a weighting factor for each description of the plurality of unique descriptions.

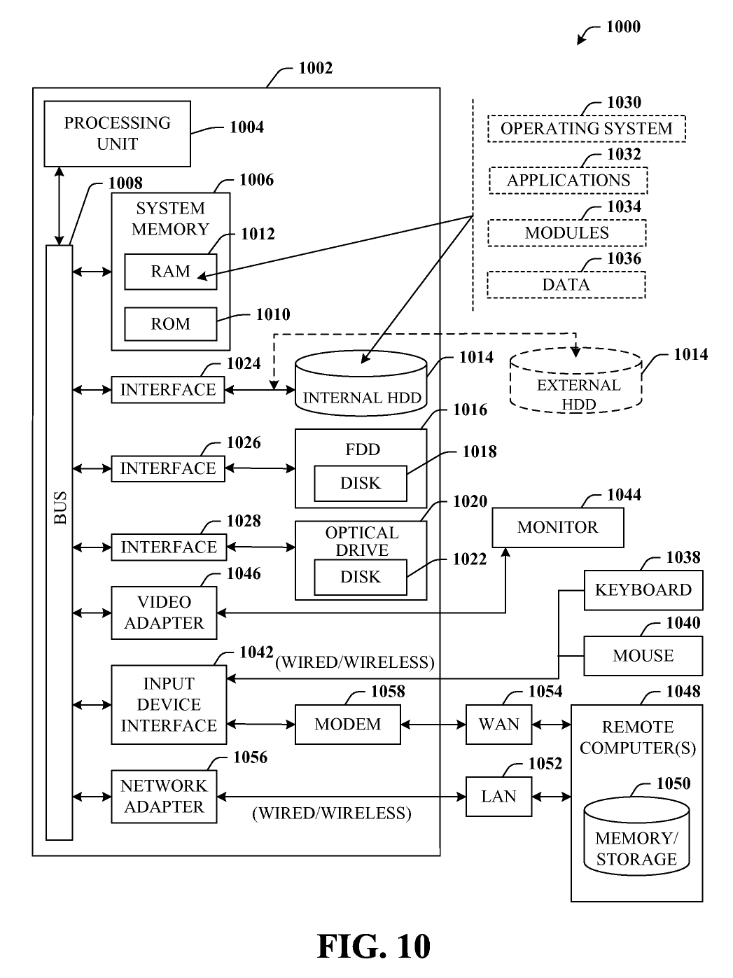

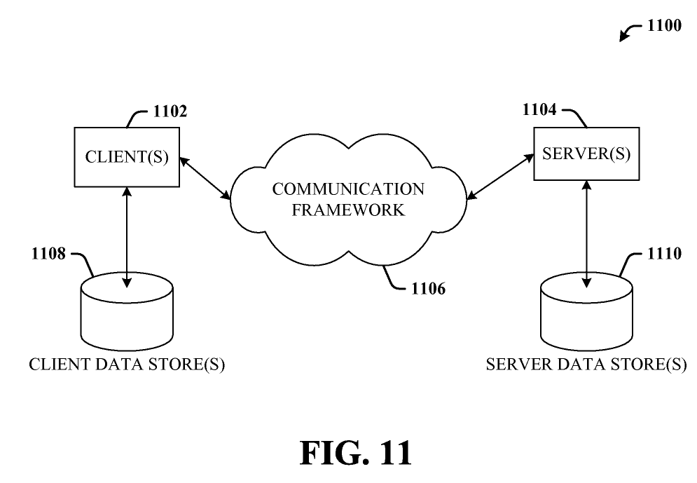

In order to provide additional context for various aspects described herein, FIGS. 10-11 and the following discussion are intended to provide a brief, general description of a suitable computing environment in which various aspects of the claimed subject matter can be implemented. Additionally, while the above features have been described above in the general context of computer-executable instructions that may run on one or more computers, those skilled in the art will recognize that said features can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, an exemplary environment 1000 for implementing various aspects described herein includes a computer 1002. The computer 1002 includes a processing unit 1004, a system memory 1006, and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

Referring now to FIG. 11, a schematic block diagram of an example networked computing environment in which various aspects described herein can function is illustrated. The system 1100 includes one or more client(s) 1102, which can be hardware and/or software (e.g., threads, processes, computing devices). In one example, the client(s) 1102 can house cookie(s) and/or associated contextual information.

The system 1100 can additionally include one or more server(s) 1104, which can also be hardware and/or software (e.g., threads, processes, computing devices). In one example, the servers 1104 can house threads to perform one or more transformations. One possible communication between a client 1102 and a server 1104 can be in the form of a data packet adapted to be transmitted between two or more computer processes. The data packet can include, for example, a cookie and/or associated contextual information. The system 1100 can further include a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. An apparatus comprising,
a multiple description (MD) encoder that encodes an input signal into a plurality of unique descriptions utilizing a plurality of sub-encoders, wherein each sub-encoder of the plurality of sub-encoders performs a linear transform and quantization of the input signal to generate one of the descriptions of the plurality of unique descriptions, and wherein the one of the descriptions of the plurality of descriptions comprises a unique coding characteristic.

2. The apparatus of claim 1, wherein the MD encoder further comprises:
an encoder controlling component that adjusts the configuration of each sub-encoder of the plurality of sub-encoders to reduce encoding errors and cross correlation between every two descriptions of the plurality of unique descriptions.

3. The apparatus of claim 1, wherein the unique coding characteristic comprises at least one of reconstructed noise of the encoded bit stream, group of pictures (GOP), group of blocks (GOB), quantization steps, cost-functions of motion estimation, code rates, compression rates, noise characteristics, or distortion correlation.

4. The apparatus of claim 1, wherein each sub-encoder of the plurality of sub-encoders comprises a linear transform block, a quantizer block, and a motion estimation block.

5. The apparatus of claim 1, wherein each sub-encoder of the plurality of sub-encoders compresses a bit stream of an associated description utilizing a unique computational complexity.

6. The apparatus of claim 1, wherein the input signal is encoded based on at least one of the following video standards: H.261, H.263, H.264, VC-1, AVS, MPEG-1, MPEG-2, MPEG-4, or other video standard or the like.

7. An apparatus comprising:
a multiple description (MD) decoder that decodes a plurality of unique descriptions associated with at least one input signal by utilizing a plurality of sub-decoders, wherein each sub-decoder of the plurality of sub-decoders is coupled to at least one of the plurality of unique descriptions, wherein the at least one of the plurality of unique descriptions comprises a unique coding characteristic, and wherein the sub-decoder decodes the at least one of the plurality of unique descriptions based on coding noise variance of the at least one of the plurality of unique descriptions and a coding error correlation coefficient associated with the at least one of the plurality of unique descriptions; and
a joint reconstruction component that reconstructs the at least one input signal based on, at least in part, extracting the unique coding characteristic associated with each description of the plurality of unique descriptions and estimating a weighting factor for each description of the plurality of unique descriptions.

8. The apparatus of claim 7, wherein the unique coding characteristic comprises at least one of: reconstructed noise of the decoded at least one of the plurality of unique descriptions, group of pictures (GOP), group of blocks (GOB), quantization steps, cost-functions of motion estimation, code rates, compression rates, noise characteristics, or distortion correlation.

9. The apparatus of claim 7, wherein the unique coding characteristic comprises L-dimension information, wherein L is an integer less than or equal to an amount of the plurality of unique descriptions.

10. The apparatus of claim 7, wherein the weighting factor is calculated by the following equation:
$$\begin{matrix}[ \begin{matrix}{w}_{1} \\ {w}_{2} \\ ⋮ \\ {w}_{l}\end{matrix} ] = {M}_{V} \cdot [ \begin{matrix}{σ}_{v 1}^{2} - {σ}_{v 1} {σ}_{vn} {ρ}_{1 n} \\ {σ}_{v 2}^{2} - {σ}_{v 2} {σ}_{vn} {ρ}_{2 n} \\ ⋮ \\ {σ}_{vn - 1}^{2} - {σ}_{vn - 1} {σ}_{vn} {ρ}_{( n - 1 ) n}\end{matrix} ] , \\ wherein \\ {M}_{v} = {[ \begin{matrix}{E [ ( {v}_{1} - {v}_{n} ) ]}^{2} ] & E ( [ {v}_{1} - {v}_{n} ) ( {v}_{1} - {v}_{n} ) ] & … & E [ ( {v}_{n - 1} - {v}_{n} ) ( {v}_{1} - {v}_{n} ) ] \\ E [ ( {v}_{1} - {v}_{n} ) ( {v}_{2} - {v}_{n} ) & {E [ ( {v}_{2} - {v}_{n} ) ]}^{2} ] & … & … \\ ⋮ & ⋮ & ⋮ & ⋮ \\ E [ ( {v}_{1} - {v}_{n} ) ( {v}_{n - 1} - {v}_{n} ) & … & … & {E [ ( {v}_{n - 1} - {v}_{n} ) ]}^{2} ]\end{matrix} ]}^{- 1}\end{matrix}$$
, and wherein
$${\sum }_{i = 1}^{n} {w}_{n} = 1.$$

11. The apparatus of claim 7, wherein each sub-decoder of the plurality of sub-decoders comprises an inverse linear transform block, a de-quantizer block, and a motion compensation block.

12. The apparatus of claim 7, wherein the at least one input signal is reconstructed based on at least one of the following video standards: H.261, H.263, H.264, VC-1, AVS, MPEG-1, MPEG-2, MPEG-4, or other video standard or the like.

13. The apparatus of claim 7, wherein each sub-decoder of the plurality of sub-decoders decodes the at least one of the plurality of unique descriptions based on, at least in part, a unique computational complexity.

14. The apparatus of claim 7, wherein the at least one input signal comprises at least one of video information, audio information, 3-dimensional image information, or graphical data.

15. The apparatus of claim 7, wherein one or more sub-decoders of the plurality of sub-decoders partially decodes an associated unique description, and wherein the joint reconstruction component reconstructs the at least one input signal as a function of a combination of the partially decoded unique descriptions.

16. The apparatus of claim 7, wherein at least two sub-decoders of the plurality of sub-decoders are associated with different input signals and jointly decode descriptions related to an associated input signal, and wherein the joint reconstruction component reconstructs the different input signals based on the jointly decoded descriptions.

17. A method comprising:
decoding at least two unique descriptions associated with at least one input video signal as a function of coding noise variance and coding error correlation of the at least two unique descriptions; and
reconstructing the at least one input video signal by at least:
extracting characteristics associated with the at least two unique descriptions; and
estimating an optimal weighting factor for each description of the at least two unique descriptions.

18. The method of claim 17, wherein the characteristics comprise at least one of: reconstructed noise of the at least two unique descriptions, group of pictures (GOP), group of blocks (GOB), quantization steps, cost-functions of motion estimation, code rates, compression rates, noise characteristics, or distortion correlation.

19. The method of claim 17, wherein the optimal weighting factor of each description of the at least two unique descriptions is calculated by the following equation:
$$\begin{matrix}[ \begin{matrix}{w}_{1} \\ {w}_{2} \\ ⋮ \\ {w}_{l}\end{matrix} ] = {M}_{V} \cdot [ \begin{matrix}{σ}_{v 1}^{2} - {σ}_{v 1} {σ}_{vn} {ρ}_{1 n} \\ {σ}_{v 2}^{2} - {σ}_{v 2} {σ}_{vn} {ρ}_{2 n} \\ ⋮ \\ {σ}_{vn - 1}^{2} - {σ}_{vn - 1} {σ}_{vn} {ρ}_{( n - 1 ) n}\end{matrix} ] , \\ wherein \\ {M}_{v} = {[ \begin{matrix}{E [ ( {v}_{1} - {v}_{n} ) ]}^{2} ] & E ( [ {v}_{1} - {v}_{n} ) ( {v}_{1} - {v}_{n} ) ] & … & E [ ( {v}_{n - 1} - {v}_{n} ) ( {v}_{1} - {v}_{n} ) ] \\ E [ ( {v}_{1} - {v}_{n} ) ( {v}_{2} - {v}_{n} ) & {E [ ( {v}_{2} - {v}_{n} ) ]}^{2} ] & … & … \\ ⋮ & ⋮ & ⋮ & ⋮ \\ E [ ( {v}_{1} - {v}_{n} ) ( {v}_{n - 1} - {v}_{n} ) & … & … & {E [ ( {v}_{n - 1} - {v}_{n} ) ]}^{2} ]\end{matrix} ]}^{- 1} , \\ and {\sum }_{i = 1}^{n} {w}_{n} = 1.\end{matrix}$$

20. A computer readable medium having stored thereon computer executable instructions for carrying out the method of claim 17.
